(19) United States
(12) Patent Application Publication
(10) Pub. No.: US 2024/0409846 A1
(43) Pub. Date: Dec. 12, 2024

(54) SOLID LAUNDRY DRAINAGE AID COMPOSITION

(71) Applicant: Dow Silicones Corporation, Midland, MI (US)

(72) Inventors: Serge Creutz, Liege (BE); Rahma Benbakoura, Quaregnon (BE); Jacqueline L'hostis, Silly (BE); Flore Vandemeulebroucke, Manage (BE)

(21) Appl. No.: 18/700,427

(22) PCT Filed: Oct. 25, 2022
(86) PCT No.: PCT/US2022/047627

§ 371 Date: Apr. 11, 2024

Related U.S. Application Data
(60) Provisional application No. 63/272,700, filed on Oct. 28, 2021.

(51) Int. Cl. C11D 3/37; C11D 3/40; C11D 17/00; D06F 35/00

(52) U.S. Cl. CPC C11D 3/373; C11D 3/40; C11D 17/0034; D06F 35/005; C11D 2111/12

(57) ABSTRACT

A solid laundry drainage aid is provided, including: 45-99.99 wt % solid carrier; and 0.01-25 wt % drainage aid component, comprising: 40-99 wt %, based on weight drainage aid component, of an organopolysiloxane comprising: 0-60 mol % of units of formula I and 40-100 mol % of units of formula II

Rₓ¹SiO_{(4-x)/2} (I)

R_{y}¹R_{z}²SiO_{(4-y-z)/2} (II)

wherein x is 0-3; y is 0-2; z is 1-2; y+z is 1-3; R¹ is a hydrogen, a hydroxy group or a group having 1 to 8 carbon atoms; R² is an -A_{c}R³ group; A is a divalent linking group; c is 0-1; R³ is a group having 9-35 carbon atoms; 1-30 wt %, based on weight drainage aid component, of an organosilicon resin; and 0-30 wt %, based on weight drainage aid component, of a hydrophobic additive; wherein the solid laundry drainage aid contains <3 wt % laundry actives; and wherein the solid laundry drainage aid contains <5 wt % water.

The present invention relates to a solid laundry drainage aid composition. In particular, the present invention relates to a solid laundry drainage aid composition, comprising: 45 to 99.99 wt %, based on weight of the solid laundry drainage aid composition, of a solid carrier; and 0.01 to 25 wt %, based on weight of the solid laundry drainage aid composition, of a drainage aid component, wherein the drainage aid component comprises: 40 to 99 wt %, based on weight of the drainage aid component, of an organopolysiloxane comprising: 0 to 60 mol % of units of formula I and 40 to 100 mol % of units of formula II

Rₓ¹SiO_{(4-x)/2} (I)

R_{y}¹R_{z}²SiO_{(4-y-z)/2} (II)

wherein x is selected from the group consisting of 0, 1, 2 and 3; wherein y is selected from the group consisting of 0, 1 and 2; wherein z is selected from the group consisting of 1 and 2; with the proviso that y+z is 1, 2 or 3; wherein each R¹ is independently selected from a hydrogen, a hydroxy group and a group having 1 to 8 carbon atoms; wherein each R² is an -A_{c}R³ group; wherein A is a divalent linking group; wherein c is selected from the group consisting of 0 and 1; wherein each R³ is independently selected from a group having 9 to 35 carbon atoms; 1 to 30 wt %, based on weight of the drainage aid component, of an organosilicon resin; and 0 to 30 wt %, based on weight of the drainage aid component, of a hydrophobic additive; wherein the solid laundry drainage aid composition contains <3 wt % laundry actives; and wherein the solid laundry drainage aid composition contains less than 5 wt % water.

There is increasing pressure from governments and consumers to improve the energy efficiency of daily activities such as cleaning laundry. A historical approach to improving the energy efficiency of cleaning laundry has been the development of laundry detergent formulations that offer cleaning at reduced washing temperatures. However, consumers are increasingly exhibiting a tendency to increase the temperature of the wash having a perception that higher wash temperatures will better facilitate the killing of contaminant microbes present in the laundry. That is, while consumers desire energy efficiency, many are unwilling to sacrifice efficacy in return for energy efficiency. Accordingly, there is a need for additives that a consumer may apply, independent of other laundry products, to reduce carbon footprint by enhancing the energy efficiency of the laundry cleaning process while facilitating the continued use of the consumer's current trusted laundry products.

Accordingly, there remains a desire to find alternative ways to reduce the energy needed to do laundry. One approach to further improve the energy efficiency of the laundry process would be to reduce the energy required to dry laundry after washing. A way to achieve that end might involve the enhanced removal of residual water from the laundry during the spinning cycle leaving fabrics drier when removed from the washer. Drier fabrics out of the washer would result in less water requiring removal during the drying process. In addition, better removal of residual water from the fabrics might also be anticipated to reduce malodor; particularly when drying is performed in under humid conditions (e.g., line drying during the wet season).

Hence, there remains a need for new solid laundry drainage aid compositions that facilitate a reduction in the energy demand associated with the washing of laundry. In particular, there remains a need for new solid laundry drainage aid composition that enhance the removal of residual water from fabrics during the rinse cycle.

The present invention provides a solid laundry drainage aid composition, comprising: 45 to 99.99 wt %, based on weight of the solid laundry drainage aid composition, of a solid carrier; and 0.01 to 25 wt %, based on weight of the solid laundry drainage aid composition, of a drainage aid component, wherein the drainage aid component comprises: 40 to 99 wt %, based on weight of the drainage aid component, of an organopolysiloxane comprising: 0 to 60 mol % of units of formula I and 40 to 100 mol % of units of formula II

Rₓ¹SiO_{(4-x)/2} (I)

R_{y}¹R_{z}²SiO_{(4-y-z)/2} (II)

wherein x is selected from the group consisting of 0, 1, 2 and 3; wherein y is selected from the group consisting of 0, 1 and 2; wherein z is selected from the group consisting of 1 and 2; with the proviso that y+z is 1, 2 or 3; wherein each R¹ is independently selected from a hydrogen, a hydroxy group and a group having 1 to 8 carbon atoms; wherein each R² is an -A_{c}R³ group; wherein A is a divalent linking group; wherein c is selected from the group consisting of 0 and 1; wherein each R³ is independently selected from a group having 9 to 35 carbon atoms; 1 to 30 wt %, based on weight of the drainage aid component, of an organosilicon resin; and 0 to 30 wt %, based on weight of the drainage aid component, of a hydrophobic additive; wherein the solid laundry drainage aid composition contains <3 wt % laundry actives; and wherein the solid laundry drainage aid composition contains less than 5 wt % water.

The present invention provides a solid laundry drainage aid composition, comprising: 45 to 99.99 wt %, based on weight of the solid laundry drainage aid composition, of a solid carrier; and 0.01 to 25 wt %, based on weight of the solid laundry drainage aid composition, of a drainage aid component, wherein the drainage aid component comprises: 40 to 99 wt %, based on weight of the drainage aid component, of a linear organopolysiloxane of formula III

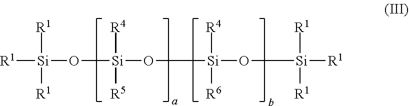

wherein each R is a methyl group; wherein each R is independently selected from the group consisting of a hydrogen, a group having 1 to 8 carbon atoms, an R⁵ and an R⁶; wherein each R⁵ is an -A_{c}R⁷ group; wherein each R⁷ is independently selected from an acyclic group having 10 to 20 carbon atoms; wherein c is 0; and wherein each R⁶ is independently selected from the group consisting of styrene, α-methyl styrene, eugenol, allylbenzene, allyl phenyl ether, 2-allylphenol, 2-chlorostyrene, 4-chlorostyrene, 4-methylstyrene, 3-methylstyrene, 4-t-butylstyrene, 2,4-dimethylstyrene, 2,5-dimethylstyrene, 2,4,6-trimethylstyrene and mixtures thereof; wherein a is 10 to 500; wherein b is 0 to 250; wherein a+b is 10 to 500; wherein a>b; and wherein ≥60 mol % of the Si atoms in the linear organopolysiloxane of formula III have an R⁵ group attached; 1 to 30 wt %, based on weight of the drainage aid component, of an organosilicon resin; and 0 to 30 wt %, based on weight of the drainage aid component, of a hydrophobic additive; wherein the solid laundry drainage aid composition contains <3 wt % laundry actives; and wherein the solid laundry drainage aid composition contains less than 5 wt % water.

The present invention provides a drainage aid unit dose comprising 2 to 40 g of a solid laundry drainage aid composition of the present invention.

The present invention provides a method for washing laundry comprising: adding a soiled fabric article to a laundry washing machine or a laundry wash basin; dosing to the laundry washing machine or the laundry wash basin a solid laundry drainage aid composition of the present invention; optionally dosing to the laundry washing machine or the laundry wash basin at least one of a laundry detergent formulation, a fabric softening formulation, a refresher formulation and a laundry scent additive; dosing a wash water to the laundry washing machine or the laundry wash basin; applying the wash water to the soiled fabric article to provide a washed fabric article; dosing a rinse water to the laundry washing machine or the laundry wash basin; applying the rinse water to the washed fabric article; and spinning the rinse water from the washed fabric article in a spin cycle; wherein at least one of the wash water and the rinse water is exposed to the solid laundry drainage aid composition before or during application thereof to the soiled or washed fabric article.

The present invention provides a method of improving the energy efficiency of machine washing laundry, comprising: adding a soiled fabric article to a laundry washing machine; selecting a solid laundry drainage aid composition of the present invention; dosing the solid laundry drainage aid composition to the laundry washing machine; dosing a laundry detergent formulation to the laundry washing machine; dosing a wash water to the laundry washing machine; applying the wash water and laundry detergent formulation to the soiled fabric article to provide a washed fabric article; dosing a rinse water to the laundry washing machine or the laundry wash basin; applying the rinse water to the washed fabric article; and spinning the rinse water from the washed fabric article in a spin cycle; wherein at least one of the wash water and the rinse water is exposed to the solid laundry drainage aid composition before or during application thereof to the soiled or washed fabric article; and wherein the organopolysiloxane in the selected solid laundry drainage aid composition is chosen based on the ability to reduce residual water entrained with the washed fabric article at completion of the spin cycle.

### DETAILED DESCRIPTION

Surprisingly, a solid laundry drainage aid composition of the present invention can be separately dosed to laundry along with other laundry treatment products (e.g., laundry detergent formulations) to facilitate exceptional water removal from laundry during the rinse cycle; providing the opportunity for significant energy savings.

Unless otherwise indicated, ratios, percentages, parts, and the like are by weight. Weight percentages (or wt %) in the composition are percentages of dry weight, i.e., excluding any water that may be present in the composition. Percentages of monomer units in the polymer are percentages of solids weight, i.e., excluding any water present in a polymer emulsion.

As used herein, unless otherwise indicated, the terms “weight average molecular weight” and “Mw” are used interchangeably to refer to the weight average molecular weight as measured in a conventional manner with gel permeation chromatography (GPC) and conventional standards, such as polystyrene standards. GPC techniques are discussed in detail in Modem Size Exclusion Chromatography, W. W. Yau, J. J. Kirkland, D. D. Bly; Wiley-Interscience, 1979, and in A Guide to Materials Characterization and Chemical Analysis, J. P. Sibilia; VCH, 1988, p. 81-84. Weight average molecular weights are reported herein in units of Daltons.

The term “solid” in reference to the solid laundry drainage aid composition of the present invention means that the laundry drainage aid composition does not perceptibly change shape when placed on a rigid surface and left to stand at room temperature, 22° C., and pressure, 101.4 kPa, for 24 hours.

Preferably, the solid laundry drainage aid composition, comprising: 45 to 99.99 wt % (preferably, 50 to 99.9 wt %; more preferably, 55 to 99.7 wt %; most preferably, 80 to 99.5 wt %), based on weight of the solid laundry drainage aid composition, of a solid carrier; and 0.01 to 25 wt % (preferably, 0.05 to 10 wt %; more preferably, 0.1 to 7.5 wt %; most preferably, 0.5 to 5 wt %), based on weight of the solid laundry drainage aid composition, of a drainage aid component, wherein the drainage aid component comprises: 40 to 99 wt % (preferably, 55 to 99 wt %; more preferably, 65 to 98 wt %; most preferably, 77 to 97 wt %), based on weight of the drainage aid component, of an organopolysiloxane comprising: 0 to 60 mol % of units of formula I and 40 to 100 mol % of units of formula II

Rₓ¹SiO_{(4-x)/2} (I)

R_{y}¹R_{z}²SiO_{(4-y-z)/2} (II)

wherein x is selected from the group consisting of 0, 1, 2 and 3; wherein y is selected from the group consisting of 0, 1 and 2 (preferably, 0 and 1; more preferably, 1); wherein z is selected from the group consisting of 1 and 2 (preferably, 1); with the proviso that y+z is 1, 2 or 3 (preferably, 2); wherein each R¹ is independently selected from a hydrogen, a hydroxy group and a group having 1 to 8 carbon atoms (preferably, a C₁₋₄ alkyl group; more preferably, a C₁₋₂ alkyl group; most preferably, a methyl group)(preferably, wherein ≤one R¹ per Si is a hydroxy group); wherein each R² is an -A_{c}R³ group; wherein A is a divalent linking group; wherein c is selected from the group consisting of 0 and 1 (preferably, 1); wherein each R³ is independently selected from a group having 9 to 35 carbon atoms (preferably, 10 to 30 carbon atoms; more preferably, 10 to 20 carbon atoms; most preferably, 10 to 15 carbon atoms); 1 to 30 wt % (preferably, 1 to 25 wt %; more preferably, 2 to 20 wt %; most preferably, 3 to 15 wt %), based on weight of the drainage aid component, of an organosilicon resin; and 0 to 30 wt % (preferably, 0 to 20 wt %; more preferably, 0 to 15 wt %; most preferably, 0 to 8 wt %), based on weight of the drainage aid component, of a hydrophobic additive; wherein the solid laundry drainage aid composition contains <3 wt % (preferably, <2 wt %; more preferably, <1 wt %; still more preferably, <0.1 wt %; yet more preferably, <0.01 wt %; most preferably, <0.0001 wt %) laundry actives.

The solid laundry drainage aid composition of the present invention, comprises: 45 to 99.99 wt % (preferably, 50 to 99.9 wt %; more preferably, 55 to 99.7 wt %; most preferably, 80 to 99.5 wt %), based on weight of the solid laundry drainage aid composition, of a solid carrier. Preferably, the solid laundry drainage aid composition of the present invention, comprises: 45 to 99.99 wt % (preferably, 50 to 99.9 wt %; more preferably, 55 to 99.7 wt %; most preferably, 80 to 99.5 wt %), based on weight of the solid laundry drainage aid composition, of a solid carrier; wherein the solid carrier is selected from the group consisting of polyethylene; polypropylene; copolymers of polyethylene and polypropylene; polyesters (e.g., polyethylene glycol); biodegradable polymers (e.g., polylactide and polyglycolic acid); polyurethanes; polyamides; polycarbonates; polysulfonates; polysiloxanes; polydienes (e.g., polybutylene, natural rubbers and synthetic rubbers); polyacrylates (e.g., polymethylmethacrylate); polystyrene; polyacrylonitrile butadiene styrene terpolymer; starch and mixtures thereof. More preferably, the solid laundry drainage aid composition of the present invention, comprises: 45 to 99.99 wt % (preferably, 50 to 99.9 wt %; more preferably, 55 to 99.7 wt %; most preferably, 80 to 99.5 wt %), based on weight of the solid laundry drainage aid composition, of a solid carrier; wherein the solid carrier comprises polyethylene glycol (preferably, wherein the polyethylene glycol has a weight average molecular weight of 2,000 to 20,000 Daltons (preferably, 3,000 to 15,000 Daltons; more preferably, 4,000 to 12,000 Daltons; still more preferably, 5,000 to 11,000 Daltons; most preferably, 7,000 to 9,000 Daltons)). Still more preferably, the solid laundry drainage aid composition of the present invention, comprises: 45 to 99.99 wt % (preferably, 50 to 99.9 wt %; more preferably, 55 to 99.7 wt %; most preferably, 80 to 99.5 wt %), based on weight of the solid laundry drainage aid composition, of a solid carrier; wherein the solid carrier comprises 50 to 100 wt % (preferably, 55 to 95 wt %; more preferably, 60 to 95 wt %; most preferably, 65 to 92.5 wt %), based on weight of the solid carrier, of polyethylene glycol (preferably, wherein the polyethylene glycol has a weight average molecular weight of 2,000 to 20,000 Daltons (preferably, 3,000 to 15,000 Daltons; more preferably, 4,000 to 12,000 Daltons; still more preferably, 5,000 to 11,000 Daltons; most preferably, 7,000 to 9,000 Daltons)); and 0 to 50 wt % (preferably, 5 to 45 wt %; more preferably, 5 to 40 wt %; most preferably, 7.5 to 35 wt %), based on weight of the solid carrier, of starch. Most preferably, the solid laundry drainage aid composition of the present invention, comprises: 45 to 99.99 wt % (preferably, 50 to 99.9 wt %; more preferably, 55 to 99.7 wt %; most preferably, 80 to 99.5 wt %), based on weight of the solid laundry drainage aid composition, of a solid carrier; wherein the solid carrier is a polyethylene glycol (preferably, wherein the polyethylene glycol has a weight average molecular weight of 2,000 to 20,000 Daltons (preferably, 3,000 to 15,000 Daltons; more preferably, 4,000 to 12,000 Daltons; still more preferably, 5,000 to 11,000 Daltons; most preferably, 7,000 to 9,000 Daltons)).

Optionally, the solid carrier may comprise a low molecular weight polyethylene glycol to tailor certain properties of the solid carrier, such as, viscosity, melting point and water solubility. Preferably, the low molecular weight polyethylene glycol has a weight average molecular weight of 200 to 600 Daltons (preferably, 300 to 500 Daltons; more preferably, 350 to 475 Daltons; most preferably, 375 to 425 Daltons).

The polyethylene glycol used in the solid carrier may optionally include monomers other than ethylene oxide, in particular at low levels. Examples of such other monomers include other alkylene oxides (e.g., propylene oxide), glycidyl and other epoxide containing monomers, formaldehyde, organic alcohols and polyol monomers. Such other monomers can be included in the polyethylene glycol provided that the resulting material is solid at room temperature.

Preferably, the solid laundry drainage aid composition of the present invention, comprises: 0.01 to 25 wt % (preferably, 0.05 to 10 wt %; more preferably, 0.1 to 7.5 wt %; most preferably, 0.5 to 5 wt %), based on weight of the solid laundry drainage aid composition, of a drainage aid component; wherein the drainage aid component comprises: 40 to 99 wt % (preferably, 55 to 99 wt %; more preferably, 65 to 98 wt %; most preferably, 77 to 97 wt %), based on weight of the drainage aid component, of an organopolysiloxane; 1 to 30 wt % (preferably, 1 to 25 wt %; more preferably, 2 to 20 wt %; most preferably, 3 to 15 wt %), based on weight of the drainage aid component, of an organosilicon resin; and 0 to 30 wt % (preferably, 0 to 20 wt %; more preferably, 0 to 15 wt %; most preferably, 0 to 8 wt %), based on weight of the drainage aid component, of a hydrophobic additive.

Preferably, the drainage aid component comprises: 40 to 99 wt % (preferably, 55 to 99 wt %; more preferably, 65 to 98 wt %; most preferably, 77 to 97 wt %), based on weight of the drainage aid component, of an organopolysiloxane; wherein the organopolysiloxane comprises: 0 to 60 mol % of units of formula I and 40 to 100 mol % of units of formula II

Rₓ¹SiO_{(4-x)/2} (I)

R_{y}¹R_{z}²SiO_{(4-y-z)/2} (II)

wherein x is selected from the group consisting of 0, 1, 2 and 3; wherein y is selected from the group consisting of 0, 1 and 2 (preferably, 0 and 1; more preferably, 1); wherein z is selected from the group consisting of 1 and 2 (preferably, 1); with the proviso that y+z is 1, 2 or 3 (preferably, 2); wherein each R¹ is independently selected from a hydrogen, a hydroxy group and a group having 1 to 8 carbon atoms (preferably, a C₁₋₄ alkyl group; more preferably, a C₁₋₂ alkyl group; most preferably, a methyl group)(preferably, wherein ≤one R¹ per Si is a hydroxy group); wherein each R² is an -A_{c}R³ group; wherein A is a divalent linking group; wherein c is selected from the group consisting of 0 and 1 (preferably, 0); wherein each R³ is independently selected from a group having 9 to 35 carbon atoms (preferably, 10 to 30 carbon atoms; more preferably, 10 to 20 carbon atoms; most preferably, 10 to 15 carbon atoms)(preferably, wherein each R³ contains 0 to 1 oxygen atoms; more preferably, wherein each R³ contains no oxygen atoms)(preferably, wherein each R³ contains 0 nitrogen atoms)(preferably, wherein at least 50 mol % (preferably, 65 to 100 mol %; more preferably, 70 to 100 mol %; most preferably, 75 to 100 mol %) of the units of formula II in the organopolysiloxane contain at least one R²). More preferably, the drainage aid component, of the present invention, comprises: 40 to 99 wt % (preferably, 55 to 99 wt %; more preferably, 65 to 98 wt %; most preferably, 77 to 97 wt %), based on weight of the drainage aid component, of an organopolysiloxane; wherein the organopolysiloxane is a linear organopolysiloxane of formula III

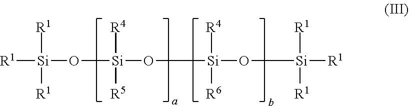

wherein each R¹ is independently selected from a hydrogen, a hydroxy group and a group having 1 to 8 carbon atoms (preferably, a C₁₋₄ alkyl group; more preferably, a C₁₋₂ alkyl group; most preferably, a methyl group)(preferably, wherein ≤one R per Si is a hydroxy group); wherein each R⁴ is independently selected from the group consisting of a hydrogen, a group having 1 to 8 carbon atoms, an R⁵ and an R⁶ (preferably, wherein each R⁴ is independently selected from a hydrogen and a group having 1 to 8 carbon atoms; more preferably, wherein each R⁴ is independently selected from a C₁₋₄ alkyl group; still more preferably, wherein each R⁴ is independently selected from a C₁₋₂ alkyl group; most preferably, wherein each R⁴ is a methyl group); wherein each R⁵ is independently selected from an acyclic group having 9 to 35 carbon atoms (preferably, 10 to 30 carbon atoms; more preferably, 10 to 20 carbon atoms; most preferably, 10 to 15 carbon atoms)(preferably, wherein each R⁵ contains 0 to 1 oxygen atoms; more preferably, wherein each R⁵ contains no oxygen atoms)(preferably, wherein each R⁵ contains 0 nitrogen atoms); wherein each R⁶ is independently selected from an alkylaryl group; wherein a is 10 to 500; wherein b is 0 to 250 and wherein a+b is 10 to 500 (preferably, 25 to 250; more preferably, 30 to 100; most preferably, 45 to 75)(preferably, wherein a≥b; more preferably, wherein a>b)(preferably, wherein ≥60 mol % (preferably, ≥65 mol %; more preferably, ≥70 mol %; most preferably, ≥75 mol %) of the Si atoms in the linear organopolysiloxane of formula I have an R⁵ group attached)(preferably, wherein b=0). Most preferably, the drainage aid component, of the present invention, comprises: 40 to 99 wt % (preferably, 55 to 99 wt %; more preferably, 65 to 98 wt %; most preferably, 77 to 97 wt %), based on weight of the drainage aid component, of an organopolysiloxane; wherein the organopolysiloxane is a linear organopolysiloxane of formula III; wherein each R¹ is independently selected from a hydrogen, a hydroxy group and a group having 1 to 8 carbon atoms (preferably, a C₁₋₄ alkyl group; more preferably, a C₁₋₂ alkyl group; most preferably, a methyl group)(preferably, wherein ≤one R per Si is a hydroxy group); wherein each R⁴ is independently selected from the group consisting of a hydrogen, a group having 1 to 8 carbon atoms, an R⁵ and an R⁶ (preferably, wherein each R⁴ is independently selected from a hydrogen and a group having 1 to 8 carbon atoms; more preferably, wherein each R⁴ is independently selected from a C₁₋₄ alkyl group; still more preferably, wherein each R⁴ is independently selected from a C₁₋₂ alkyl group; most preferably, wherein each R⁴ is a methyl group); wherein each R⁵ is an -A_{c}R⁷ group; wherein each R⁷ is independently selected from an acyclic group having 9 to 35 carbon atoms (preferably, an acyclic C₁₀₋₃₀ alkyl group; more preferably, an acyclic C₁₀₋₂₀ alkyl group; most preferably, an acyclic C₁₀₋₁₅ alkyl group)(preferably, wherein each R⁷ is a hydrocarbyl group); wherein c is selected from the group consisting of 0 and 1 (preferably, wherein c is 0); and wherein A is a divalent linking; wherein each R⁶ is a —YR⁸ group; wherein Y is selected from the group consisting of a divalent alkylene group having 2 to 10 (preferably, 2 to 4; more preferably, 2) carbon atoms and 0 to 2 (preferably, 0 to 1; more preferably, 0) oxygen atoms; and wherein R⁸ is at least one —C₆R⁹₆ aromatic ring; wherein each R⁹ is independently selected from a hydrogen, a halogen, a hydroxyl, a C₁₋₆ alkoxy group, a C₁₋₁₂ alkyl group or wherein two or more R⁹ groups together represent a divalent hydrocarbon group joining together two or more aromatic rings (preferably, wherein each R⁶ is independently selected from the group consisting of styrene, α-methyl styrene, eugenol, allylbenzene, allyl phenyl ether, 2-allylphenol, 2-chlorostyrene, 4-chlorostyrene, 4-methylstyrene, 3-methylstyrene, 4-t-butylstyrene, 2,4-dimethylstyrene, 2,5-dimethylstyrene, 2,4,6-trimethylstyrene and mixtures thereof; most preferably, α-methyl styrene); wherein a is 10 to 500; wherein b is 0 to 250 and wherein a+b is 10 to 500 (preferably, 25 to 250; more preferably, 30 to 100; most preferably, 45 to 75)(preferably, wherein a≥b; more preferably, wherein a>b)(preferably, wherein ≥60 mol % (preferably, ≥65 mol %; more preferably, ≥70 mol %; most preferably, ≥75 mol %) of the Si atoms in the linear organopolysiloxane of formula III have an R⁵ group attached)(preferably, wherein b=0).

Preferably, the organopolysiloxane of the drainage aid component has a degree of polymerization of 10 to 500. More preferably, the organopolysiloxane of the drainage aid component has a degree of polymerization of 25 to 250. Still more preferably, the organopolysiloxane of the drainage aid component has a degree of polymerization of 30 to 100. Most preferably, the organopolysiloxane of the drainage aid component has a degree of polymerization of 45 to 75.

Preferably, the organopolysiloxane of the drainage aid component is a linear organopolysiloxane; wherein the linear organopolysiloxane comprises <0.1 wt % (preferably, <0.01 wt %; more preferably, <0.001 wt %; most preferably, <detectable limit) of trifunctional siloxane units. Preferably, the organopolysiloxane of the drainage aid component is a linear organopolysiloxane; wherein the linear organopolysiloxane comprises <0.1 wt % (preferably, <0.01 wt %; more preferably, <0.001 wt %; most preferably, < the detectable limit) of trifunctional siloxane units; and wherein the linear organopolysiloxane comprises <the detectable limit of aromatic moieties (e.g., α-methyl styrene moieties).

The divalent linking group, A, when present in the organopolysiloxane of the drainage aid component, preferably consists of (i) oxygen; (ii) carbon and hydrogen; or (iii) carbon, hydrogen, oxygen and optionally nitrogen, sulfur and/or phosphorus. Oxygen when present in the divalent linking group, A, is selected from the group consisting of an ether oxygen, an ester oxygen, a substituted hydroxyl, a substituted alkoxy group and a combination thereof. Nitrogen when present in the divalent linking group, A, is selected from the group consisting of an amino group, an amido group and combinations thereof. The divalent linking group, A, when present in the organopolysiloxane is preferably selected from the group consisting of alkylene ester groups, alkylene ether groups, amide groups, polyamino/amido groups and mercapto groups, such as, —O—, —CH₂CH₂OC(═O)—, —CH₂CH₂OCH₂CH(OH)—, —(CH₂)₃NHC(═O)—, —(CH₂)₃NHCH₂C(═O)—, —CH₂CH₂S— and

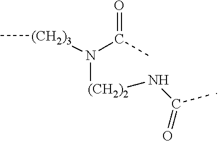

Preferably, the organopolysiloxane of the drainage aid component is nonionic.

Preferably, the drainage aid component comprises: 1 to 30 wt % (preferably, 1 to 25 wt %; more preferably, 2 to 20 wt %; most preferably, 3 to 15 wt %), based on weight of the drainage aid component, of an organosilicon resin; wherein the organosilicon resin is comprised primarily of R₃¹⁰SiO_{1/2} and SiO_{4/2} units (i.e., M and Q units, respectively); wherein each R¹⁰ is selected from the group consisting of a functional or non-functional, substituted or unsubstituted monovalent radical (preferably, a hydroxyl group, a hydrocarbon group and a hydrocarbonoxy group). The number ratio of the M groups to Q groups is preferably 0.4:1 to 2.5:1 (more preferably, 0.4:1 to 1.5:1; most preferably, 0.5:1 to 1.1:1). While the organosilicon resin preferably contains only M and Q units, the organosilicon resin may include a limited number of R₂¹⁰SiO_{2/2} and R¹⁰SiO_{3/2} units (i.e., D and T units, respectively). Preferably, the organosilicon resin is an MQ silicone resin. As used herein, the term “MQ silicone resin” means that, on average, no more than 20 mole percent (preferably, no more than 15 mole percent; more preferably, no more than 10 mole percent; still more preferably, no more than 5 mole percent; most preferably, no more than 1 mole percent) of the organosilicon units are comprised of D and T units.

Preferably, the drainage aid component comprises: 0 to 30 wt % (preferably, 0 to 20 wt %; more preferably, 0 to 15 wt %; most preferably, 0 to 8 wt %), based on weight of the drainage aid component, of a hydrophobic additive; wherein hydrophobic additive is selected from the group consisting of silica, titania, alumina, ground quartz, magnesium oxide, zinc oxide, salts of aliphatic carboxylic acids (e.g., calcium or aluminum stearates), reaction products of isocyanates with certain cyclohexylamine and alkyl amides (e.g., ethylene or methylene bis stearamide). More preferably, the drainage aid component comprises: 0 to 30 wt % (preferably, 0 to 20 wt %; more preferably, 0 to 15 wt %; most preferably, 0 to 8 wt %), based on weight of the drainage aid component, of a hydrophobic additive; wherein the hydrophobic additive is selected from silica particles. Most preferably, the drainage aid component comprises: 0 to 30 wt % (preferably, 0 to 20 wt %; more preferably, 0 to 15 wt %; most preferably, 0 to 8 wt %), based on weight of the drainage aid component, of a hydrophobic additive; wherein hydrophobic additive is selected from silica particles having an average particle size of 0.1 to 50 μm (preferably, 1 to 20 μm) and a surface area of at least 50 m²/g. The silica particles may be rendered hydrophobic, e.g., by treating with dialkylsilyl groups and/or trialkylsilyl groups either bonded directly onto the silica or by means of a silicone resin. Preferably, the silica particles are rendered hydrophobic with dimethyl and/or trimethyl silyl groups. The silica materials may be selected from fumed silica, precipitated silica, hydrothermal silica and gel formation silica.

Preferably, the drainage aid component contains <0.1 wt %, based on weight of the drainage aid component, of a hydrophobic particulate material (e.g., silica, titania, alumina, ground quartz, magnesium oxide, zinc oxide, salts of aliphatic carboxylic acids (e.g., calcium or aluminium stearates), reaction products of isocyanates with certain materials (for example cyclohexylamine and alkyl amides, e.g., ethylene or methylene bis stearamide).

Preferably, the drainage aid component optionally contains an optional material selected from the group consisting of a binder/encapsulant (e.g., a polyacrylic binder), a surfactant and a solid support.

Binders/encapsulants used in the drainage aid component may include polyoxyalkylene polymers (e.g., polyethylene glycol, which can be applied molten or as an aqueous solution and spray dried); reaction products of tallow alcohol and ethylene oxide or polypropylene glycol; polycarboxylates (e.g., polyacrylic acid, partial sodium salts of polyacrylic acid, copolymers of acrylic acid and maleic anhydride); cellulose ethers (e.g., sodium carboxymethylcellulose); gelatin; agar; microcrystalline waxes; fatty acids or fatty alcohols having 12 to 20 carbon atoms and a melting point in the range 45 to 80° C.; a monoester of glycerol with such a fatty acid; a mixture of a water insoluble wax having a melting point of 55 to 100° C. and a water-insoluble emulsifying agent, glucose or hydrogenated glucose.

Surfactant used in the drainage aid component can be selected to facilitate dispersal of the organopolysiloxane from the binder/encapsulant. Silicone glycols are preferred surfactants for use in combination with many binder/encapsulants. Fatty alcohol ether sulphates or linear alkylbenzene sulphonates are preferred for use in combination with polyacrylic acid type binder/encapsulants. The surfactant may be added to the organopolysiloxane of the drainage aid component undiluted or in emulsion before the organopolysiloxane is mixed with the binder/encapsulant, or the surfactant and the organopolysiloxane may successively be added to the binder/encapsulant.

Solid support used in the drainage aid component is preferably selected from zeolites (e.g. Zeolite A, Zeolite X), aluminosilicates, silicates (e.g., magnesium silicate), phosphates (e.g., powdered or granular sodium tripolyphosphate), sodium sulphate, sodium carbonate, sodium perborate, a cellulose derivative (e.g., sodium carboxymethylcellulose), granulated starch, clay, sodium citrate, sodium acetate, sodium bicarbonate and native starch.

Preferably, the solid laundry drainage aid composition of the present invention, further comprises an optional ingredient selected from the group consisting of a fragrance, a dye, a particulate spacer, a cationic polymer, a softening silicone, a foam regulator, filler and a processing aid.

Preferably, the solid laundry drainage aid composition of the present invention, optionally further comprises 0 to 25 wt % (preferably, 0 to 24 wt %; preferably, 4 to 24 wt %), based on weight of the solid laundry drainage aid composition, of a fragrance. More preferably, the solid laundry drainage aid composition of the present invention, optionally further comprises 0 to 25 wt % (preferably, 0 to 24 wt %; preferably, 4 to 24 wt %), based on weight of the solid laundry drainage aid composition, of a fragrance; wherein the fragrance is selected from the group consisting of a free perfume, a pro-perfume, an encapsulated perfume and mixtures thereof (preferably, wherein the fragrance is a mixture of a free perfume and an encapsulated perfume). Most preferably, the solid laundry drainage aid composition of the present invention, optionally further comprises: 2 to 12 wt %, based on weight of the solid laundry drainage aid composition, of a free perfume and 2 to 12 wt %, based on weight of the solid laundry drainage aid composition, of an encapsulated perfume.

The term “perfume” used herein and in the appended claims refers to an odoriferous material that is released from the solid laundry drainage aid composition of the present invention into at least one of (a) the wash water used to clean laundry, (b) the rinse water used to clean laundry and (c) the laundry contacted with (a) or (b). The perfume used in the solid laundry drainage aid composition will typically be a liquid a ambient temperatures. A range of substances are known for use as perfumes including, for example, aldehydes, ketones and esters. Naturally occurring plant and animal oils and exudates comprised of complex mixtures of components are known for use as perfumes. Perfumes may comprises woody/earthy bases with exotic materials including sandalwood, civet and patchouli oil. The perfume may be of a light floral fragrance such as rose extract, lilac and violet extract. The perfume may provide fruity odors such as lime, lemon and orange. The perfume may deliver an aromatherapy effect, such as providing a relaxing or invigorating mood.

The term “pro-perfume” used herein and in the appended claims refers to a perfume precursor that releases a desirable odor and/or perfume molecule through the breaking of a chemical bond. Typically a pro-perfume is a desired perfume raw material chemically linked to a carrier (preferably, wherein the carrier is slightly or sparingly volatile). The pro-perfume is frequently designed to increase deposition onto a fabric article. The perfume fragrance is subsequently released through breaking of the bond between the perfume raw material and the carrier through a change in pH (e.g., exposure to perspiration), moisture in the environment, heat, enzymatic action, exposure to sunlight during storage or line drying.

The term “free perfume” used herein and in the appended claims refers to perfume that contains less than 0.1 wt %, based on weight of the perfume, of a perfume carrier; wherein the perfume carrier is selected from the group consisting of cyclodextrin, zeolites and combinations thereof.

The term “encapsulated perfume” used herein and in the appended claims refers to perfume that is encapsulated. The encapsulated perfume can be friable or moisture activated. Preferably, the encapsulated perfume comprises a perfume encapsulated by a melamine/formaldehyde shell. Encapsulated perfumes are commercially available from, for example, Appleton, Quest International and International Flavor & Fragrances.

Preferably, the solid laundry drainage aid composition of the present invention, optionally further comprises 0 to 0.1 wt % (preferably, 0.001 to 0.1 wt %; more preferably, 0.01 to 0.02 wt %), based on weight of the solid laundry drainage aid composition, of a dye. Dyes used in the solid laundry drainage aid composition may include those typically used in laundry treating products (e.g., detergent, fabric softener).

The solid laundry drainage aid composition of the present invention, optionally further comprises 0 to 50 wt % (preferably, 0 to 45 wt %; more preferably, 0 to 40 wt %), based on weight of the solid laundry drainage aid composition, of a particulate spacer material. Preferably, the solid laundry drainage aid composition of the present invention, optionally further comprises 0 to 50 wt % (preferably, 0 to 45 wt %; more preferably, 0 to 40 wt %), based on weight of the solid laundry drainage aid composition, of a particulate spacer material; wherein the particulate spacer material has a mean particle size of 55 to 750 microns (preferably, 75 to 650 microns; more preferably, 95 to 600 microns; most preferably, 100 to 250 microns). Preferably, the particulate spacer material is non-water soluble or exhibits a water dissolution rate significantly lower than that of the solid carrier (i.e., wherein the dissolution rate of the solid carrier divided by the dissolution rate of the particulate spacer material is at least 2). Preferably, the particulate spacer material occupies 0 to 0.5 vol % (preferably, 0.1 to 0.5 vol %; more preferably, 0.15 to 0.45 vol %; most preferably, 0.2 to 0.45 vol %) of the solid laundry drainage aid composition of the present invention. The particulate spacer material may have a variety of shapes including spherical, polyhedron, granule, fibrillar and crystalline. Preferably, the particulate spacer material is a solid over the temperature range of 25 to 70° C. The particulate spacer material is preferably selected from the group consisting of organic particulate material, inorganic particulate material and combinations thereof. Preferably, the particulate spacer material is selected from the group consisting of alkali metal borates (e.g., sodium borate, sodium tetraborate, disodium tetraborate, potassium tetraborate); glass microspheres (e.g., soda lime glass microspheres, hollow glass microspheres, borosilicate solid glass microspheres); polyalkylene microspheres (e.g., polyethylene microspheres, polypropylene microspheres); ceramic microspheres and mixtures thereof.

Preferably, the solid laundry drainage aid composition of the present invention, optionally further comprises 0 to 2.5 wt % (preferably, 0.1 to 2.5 wt %; more preferably, 0.1 to 2 wt %; most preferably, 0.1 to 1.5 wt %), based on weight of the solid laundry drainage aid composition, of a cationic polymer. More preferably, the solid laundry drainage aid composition of the present invention, optionally further comprises 0 to 2.5 wt % (preferably, 0.1 to 2.5 wt %; more preferably, 0.1 to 2 wt %; most preferably, 0.1 to 1.5 wt %), based on weight of the solid laundry drainage aid composition, of a cationic polymer; wherein the cationic polymer is selected from the group consisting of cationic polysaccharide polymers, cationic non-saccharide polymers having a cationic protonated amine or quaternary ammonium functionalities that are homo or copolymers derived from monomers containing an amino or quaternary nitrogen functional group polymerized from a least one of an acrylate, a methacrylate, an acrylamide, a methacrylamide, diallyl, methallyl, ethylene imine (preferably, a cationic polysaccharide polymer). Preferred cationic polysaccharide polymers include cationic guar polymer and carionic cellulose polymer. Most preferred cationic polysaccharide polymers are cationic cellulose polymers (e.g., quaternized hydroxy ethyl cellulose polymer).

Preferably, the solid laundry drainage aid composition of the present invention, optionally further comprises 0 to 5 wt % (preferably, 0.1 to 5 wt %; more preferably, 0.2 to 5 wt %; most preferably, 0.5 to 4 wt %), based on weight of the solid laundry drainage aid composition, of a softening silicone. More preferably, the solid laundry drainage aid composition of the present invention, optionally further comprises 0 to 5 wt % (preferably, 0.1 to 5 wt %; more preferably, 0.2 to 5 wt %; most preferably, 0.5 to 4 wt %), based on weight of the solid laundry drainage aid composition, of a softening silicone; wherein the softening silicone is selected from the group consisting of polydimethylsiloxane, silicone polyether, quaternary silicone, cationic silicone, aminosilicone and anionic silicone (e.g., silicones that incorporate a carboxylic, sulphate, sulphonic, phosphate and/or phosphonate functionality).

Preferably, the solid laundry drainage aid composition of the present invention, optionally further comprises a foam regulator. More preferably, the solid laundry drainage aid composition of the present invention, optionally further comprises a foam regulator; wherein the foam regulator is selected from the group consisting of organomodified silicones, polydimethyl silicones and fatty acids. Most preferably, the solid laundry drainage aid composition of the present invention, optionally further comprises a foam regulator; with the proviso that when the foam regulator is an organomodified silicone, said organomodified silicone is compositionally different from that included in the drainage aid component.

Preferably, the solid laundry drainage aid composition of the present invention, optionally further comprises a filler. More preferably, the solid laundry drainage aid composition of the present invention, optionally further comprises a filler; wherein the filler includes at least one of sodium sulfate, sodium chloride, calcite and dolomite. Most preferably, the solid laundry drainage aid composition of the present invention, optionally further comprises a filler; wherein the filler is selected from the group consisting of sodium sulfate, sodium chloride, calcite, dolomite and mixtures thereof.

Preferably, the solid laundry drainage aid composition of the present invention contains less than 5 wt % (preferably, less than 3 wt %; more preferably, less than 1 wt %; most preferably, is free of (i.e., anhydrous)) water.

Preferably, the solid laundry drainage aid composition of the present invention contains <3 wt % (preferably, <2 wt %; more preferably, <1 wt %; still more preferably, <0.1 wt %; yet more preferably, <0.01 wt %; most preferably, <0.0001 wt %) laundry actives. Laundry actives include, for example, detergent surfactants, detergent builders, bleaching agents, enzymes and mixtures thereof. A non-detersive level of surfactant may be used to facilitate solubilization of the drainage aid component in the solid carrier.

Preferably, the solid laundry drainage aid composition of the present invention is provided as a pastille (more preferably, as a plurality of pastilles). More preferably, the solid laundry drainage aid composition of the present invention is provided as a pastille (more preferably, as a plurality of pastilles) having a shape selected from the group consisting of tablets, polyhedrons, granules, spheres, hemispheres, compressed hemispheres, lentils and oblong shape (preferably, hemispheres and compressed hemispheres). Most preferably, the solid laundry drainage aid composition of the present invention is provided as a plurality of pastilles having a compressed hemispherical shape. The term “compressed hemispherical” as used herein and in the appended claims refers to a shape corresponding to a hemisphere that is at least partially flattened, whereby the radius of the compressed hemisphere is shorter along an axis tangential to the flattened surface relative to the radius of the compressed hemisphere along an axis along the flattened surface. Preferably, the compressed pastilles have a ratio of height to diameter of 0.01 to 0.4 (preferably, 0.1 to 0.4; more preferably, 0.2 to 0.3). Preferably, the individual pastilles have a volume of 0.003 to 0.15 cm³. Preferably, the pastilles have a weight of 0.95 mg to 2 g. Preferably, a plurality of pastilles collectively comprise a unit dose for dosing to a laundry washing machine or a laundry wash basin. Preferably, a unit does of the solid laundry drainage aid composition of the present invention comprises 2 to 40 g (preferably, 3 to 35 g; more preferably, 4 to 30 g; most preferably, 5 to 28 g) of pastilles.

Preferably, the solid laundry drainage aid composition of the present invention is provided in a package containing a single unit dose or a plurality of unit doses. The package may be selected from the group consisting of a bottle, a bag or other suitable container. Preferably, the package is a PET bottle.

Preferably, the package containing the solid laundry drainage aid composition of the present invention comprises a dosing means for measuring and dispensing the solid laundry drainage aid composition to a washing machine or wash basin. Examples of dosing means include a dispensing cap or dome that is functionally attached to the package. The dosing means may be releasably detachable from and reatachable to the package.

Preferably, the method of making the solid laundry drainage aid composition of the present invention comprises providing a solid carrier (preferably, wherein the solid carrier has a melting point above 25° C.); heating the solid carrier (preferably, wherein the solid carrier is heated to a temperature above its melting point); providing a drainage aid component of the present invention; providing any optional ingredients (e.g., fragrance); mixing the drainage aid component and any optional ingredients with the heated solid carrier to form a melt composition; and cooling the melt composition (preferably to a temperature below the melting point temperature for the solid carrier) to form a non-porous water dissolvable (or dispersible) solid (e.g., plurality of pastilles) using well known techniques.

Preferably, the method of washing laundry of the present invention, comprises: adding a soiled fabric article (preferably, wherein the soiled fabric article comprises cotton; more preferably, wherein the soiled fabric article is selected from cotton and a polyester cotton blend); to a laundry washing machine or a laundry wash basin (preferably, to a laundry washing machine); dosing to the laundry washing machine or the laundry wash basin (preferably, to the laundry washing machine) a solid laundry drainage aid composition of the present invention; optionally dosing to the laundry washing machine or the laundry wash basin (preferably, to the laundry washing machine) at least one of a laundry detergent formulation, a fabric softening formulation, a refresher formulation and a laundry scent additive; dosing a wash water to the laundry washing machine or the laundry wash basin (preferably, to the laundry washing machine); applying the wash water to the soiled fabric article to provide a washed fabric article; dosing a rinse water to the laundry washing machine or the laundry wash basin (preferably, to the laundry washing machine); applying the rinse water to the washed fabric article; and spinning the rinse water from the washed fabric article in a spin cycle; wherein at least one of the wash water and the rinse water is exposed to the solid laundry drainage aid composition before or during application thereof to at least one of the soiled fabric article and the washed fabric article (preferably, wherein the weight of residual water entrained with the washed fabric article at completion of the spin cycle using the solid laundry drainage aid composition of the present invention divided by the weight of residual water entrained with the washed fabric article at completion of the machine rinse cycle using the same process but without addition of the solid laundry drainage aid composition is ≤0.7 (preferably, ≤0.6; more preferably, ≤0.55; most preferably, ≤0.50)).

Preferably, the method of improving the energy efficiency of machine washing laundry of the present invention, comprises: adding a soiled fabric article to a laundry washing machine (preferably, wherein the soiled fabric article comprises cotton; more preferably, wherein the soiled fabric article is selected from cotton and a polyester cotton blend); selecting a solid laundry drainage aid composition of the present invention; dosing the solid laundry drainage aid composition to the laundry washing machine; dosing a laundry detergent formulation to the laundry washing machine; dosing a wash water to the laundry washing machine; applying the wash water and laundry detergent formulation to the soiled fabric article to provide a washed fabric article; dosing a rinse water to the laundry washing machine; applying the rinse water to the washed fabric article; and spinning the rinse water from the washed fabric article in a spin cycle; wherein at least one of the wash water and the rinse water is exposed to the solid laundry drainage aid composition before or during application thereof to at least one of the soiled fabric article and the washed fabric article; and wherein the organopolysiloxane in the selected solid laundry drainage aid composition is chosen based on the ability to reduce residual water entrained with the washed fabric article at completion of the spin cycle (preferably, wherein the weight of residual water entrained with the washed fabric article at completion of the spin cycle using the solid laundry drainage aid composition of the present invention containing the selected organopolysiloxane divided by the weight of residual water entrained with the washed fabric article at completion of the machine rinse cycle using the same process but without addition of the solid laundry drainage aid composition is ≤0.7 (preferably, ≤0.6; more preferably, ≤0.55; most preferably, ≤0.50)).

Some embodiments of the present invention will now be described in detail in the following Examples.

### Examples A1-A2: Organopolysiloxanes

The organopolysiloxanes of Examples A1-A2 having the general formula

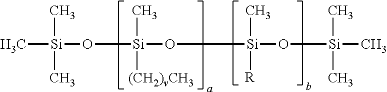

wherein the values of R, a, b and v are reported in TABLE 1.

TABLE 1

| Ex. | R | a | b | v |
|---|---|---|---|---|
| Example A1 | α-methyl styrene | 48 | 12 | 1 |
| Example A2 | α-methyl styrene | 48 | 12 | 11 |

### Example AF1: Antifoam Component

An antifoam composition comprising the ingredients as noted in TABLE 2 was prepared by homogenizing the ingredients in a dental mixer set at 3,500 rpm for 30 seconds and then in a high shear mixer (silverson) set at 6,000 rpm for one minute.

TABLE 2

| | Example AF1 |
|---|---|
| Ingredient | (wt %) |
| Example A1 | 87.3 |
| MQ silicone resin^{a} | 6.7 |
| Precipitated SiO₂^{b} | 6.0 |

^{a}Trimethylsilylated resin with a total M/Q ratio of 0.96/1 dissolved at 60% in octyl stearate
^{b}SIPERNAT ® D 10 (≥97% precipitated SiO₂ having a d50 particle size of 6.5 μm) available from Evonik

### Example AFG1: Antifoam Granules

An antifoam granule was prepared by combining the antifoam component from Example AF1 with the other ingredients as noted in TABLE 3. The binder and dodecylbenzene sulfonic acid were weighed into a container and homogenized with a mechanical stirrer (10 min/400 rpm). The water and the antifoam component were then added to the contents of the container with agitation. The contents of the container were then poured onto the zeolite carrier in a food mixer. The mixture was then dried in a fluidized bed over 20 minutes at 60° C. and sieved between 250 μm and 1,400 μm to provide the product antifoam granules.

TABLE 3

| | Example AFG1 |
|---|---|
| Ingredient | (wt %) |
| Polyacrylic binder¹ | 13.96 |
| Dodecylbenzene sulfonic acid (DBSA)² | 1.80 |
| Water | 11.02 |
| Example AF1 | 9.53 |
| Zeolite carrier³ | 63.69 |

¹Sokalan PA 25 PN~54 wt % solids in water available from BASF
²Marlon AS3 available from Sasol
³Sodium aluminum silicate available from PQ

### Example DAC: Drainage Aid Component

A drainage aid component of Example DAC comprising the ingredients noted in TABLE 4 was prepared by homogenizing the ingredients in a dental mixer set at 3,500 rpm for 30 seconds and then in a high shear mixer (silverson) set at 6,000 rpm for one minute.

TABLE 4

| | Ingredient | | | |
|---|---|---|---|---|
| Example | Organopolysiloxane | wt % | Resin | wt % |
| Example DAC | Example 1 | 80.0 | MQ silicone resin^{a} | 20.0 |

^{a}Trimethylsilylated resin with an M/Q ratio of 0.96/1 dispersed at 60% in octyl stearate.

### Example DAB: Drainage Aid Bead

A drainage aid bead was prepared by melting 99.2 g of poly(ethylene glycol) powder having a weight average molecular weight of 8,000 Daltons (PEG 8000) by heating at 60° C. Once the PEG 8000 was molten, 0.8 g of the drainage aid component from Example DAC was added and the combination was homogenized with a mechanical stirrer at 400 rpm for 10 minutes. The product was then allowed to cool down to room temperature.

### Comparative Example C1 and Example 1: Residual Water

All tests were run in a Miele W377 front loading washing machine. The machine was loaded with 4 small terry towels, 5 pillow cases and 11 liters of water at a hardness of 27.5° French degree. Antifoam granules from Example AFG1 (0.375 g) was combined using a spatula with 125 g of powder laundry detergent (Standard detergent formula 1998, ISO 105-C08:2010 available from wfk-Testgewebe GmbH) and was then loaded into the washing machine. Drainage aid beads (5 g) from Example DAB were added on top of the laundry detergent/antifoam granules in Example 1. The washing machine was then started using the Color program set at 40° C., short program and 600 rpm. The foam height was monitored every 5 minutes during the 60 min. wash and the following rinse cycle (0 being no foam and 100 being the full window of foam) as recorded in TABLE 6. The drainage aid beads, if any, (5 g) noted in TABLE 5 was added in the last rinse. At the end of the rinse cycle, the load of terry towels was removed and weighted to check the residual water content in kg at the end of the wash as recorded in TABLE 5.

TABLE 5

| Example | Drainage aid beads | Residual water (kg) |
|---|---|---|
| C1 | — | 4.1 |
| 1 | Example DAB | 1.7 |
| Time | C1 | 1 |
| 0 | 0 | 0 |
| 5 | 8 | 5 |
| 10 | 30 | 18 |
| 15 | 63 | 20 |
| 20 | 88 | 20 |
| 25 | 100 | 23 |
| 30 | 100 | 22 |
| 35 | 100 | 22 |
| 40 | 100 | 22 |
| 45 | 100 | 20 |
| 50 | 100 | 25 |
| 55 | 23 | 8 |
| 60 | 33 | 38 |
| 65 | 23 | 12 |
| 70 | 30 | 3 |
| 75 | 33 | 0 |
| 80 | 35 | 2 |
| 85 | 35 | 2 |
| 90 | 40 | 0 |
| 95 | 40 | 0 |
| 100 | 28 | 0 |
| 105 | 23 | 0 |
| 110 | 28 | 0 |
| 115 | 33 | 0 |
| 120 | 18 | 0 |
| 125 | 15 | 0 |
| 130 | 15 | 0 |

We claim:

1. A solid laundry drainage aid composition, comprising:
45 to 99.99 wt %, based on weight of the solid laundry drainage aid composition, of a solid carrier; and
0.01 to 25 wt %, based on weight of the solid laundry drainage aid composition, of a drainage aid component, wherein the drainage aid component comprises:
40 to 99 wt %, based on weight of the drainage aid component, of an organopolysiloxane comprising:
0 to 60 mol % of units of formula I
Rₓ¹SiO_{(4-x)/2} (I)
40 to 100 mol % of units of formula II
R_{y}¹R_{z}²SiO_{(4-y-z)/2} (II)
wherein x is selected from the group consisting of 0, 1, 2 and 3; wherein y is selected from the group consisting of 0, 1 and 2; wherein z is selected from the group consisting of 1 and 2; with the proviso that y+z is 1, 2 or 3; wherein each R¹ is independently selected from a hydrogen, a hydroxy group and a group having 1 to 8 carbon atoms; wherein each R² is an -A_{c}R³ group; wherein A is a divalent linking group; wherein c is selected from the group consisting of 0 and 1; wherein each R³ is independently selected from a group having 9 to 35 carbon atoms;
1 to 30 wt %, based on weight of the drainage aid component, of an organosilicon resin; and
0 to 30 wt %, based on weight of the drainage aid component, of a hydrophobic additive;
wherein the solid laundry drainage aid composition contains <3 wt % laundry actives; and
wherein the solid laundry drainage aid composition contains less than 5 wt % water.

2. The solid laundry drainage aid composition of claim 1, wherein the solid laundry drainage aid composition is provided as a plurality of pastilles having a shape selected from the group consisting of hemispherical and compressed hemispherical.

3. The solid laundry drainage aid composition of claim 2, wherein the plurality of pastilles are contained in a package having a dispensing cap releasably detachable from said package and reattachable to said package; and wherein the drainage aid pastilles have an average weight of 0.95 mg to 2 g per pastille.

4. The solid laundry drainage aid composition of claim 2, further comprising an optional additive selected from the group consisting of a fragrance, a dye, a particulate spacer material and combinations thereof.

5. The solid laundry drainage aid composition of claim 2, wherein the solid laundry drainage aid composition further comprises a fragrance.

6. The solid laundry drainage aid composition of claim 2, wherein the solid laundry drainage aid composition further comprises a particulate spacer material.

7. The solid laundry drainage aid composition of claim 2, wherein the organopolysiloxane is a linear organopolysiloxane of formula III 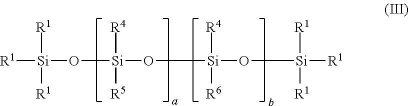
wherein each R¹ is a methyl group; wherein each R⁴ is independently selected from the group consisting of a hydrogen, a group having 1 to 8 carbon atoms, an R⁵ and an R⁶; wherein each R⁵ is an -A_{c}R⁷ group; wherein each R⁷ is independently selected from an acyclic group having 10 to 20 carbon atoms; wherein c is 0; and wherein each R⁶ is independently selected from the group consisting of styrene, α-methyl styrene, eugenol, allylbenzene, allyl phenyl ether, 2-allylphenol, 2-chlorostyrene, 4-chlorostyrene, 4-methylstyrene, 3-methylstyrene, 4-t-butylstyrene, 2,4-dimethylstyrene, 2,5-dimethylstyrene, 2,4,6-trimethylstyrene and mixtures thereof; wherein a is 10 to 500; wherein b is 0 to 250; wherein a+b is 10 to 500; wherein a>b; and wherein ≥60 mol % of the Si atoms in the linear organopolysiloxane of formula III have an R⁵ group attached.

8. A drainage aid unit dose comprising 2 to 40 g of the plurality of pastilles according to claim 2.

9. A method for washing laundry comprising:
adding a soiled fabric article to a laundry washing machine or a laundry wash basin;
dosing to the laundry washing machine or the laundry wash basin a solid laundry drainage aid composition according to claim 1;
optionally dosing to the laundry washing machine or the laundry wash basin at least one of a laundry detergent formulation, a fabric softening formulation, a refresher formulation and a laundry scent additive;
dosing a wash water to the laundry washing machine or the laundry wash basin;
applying the wash water to the soiled fabric article to provide a washed fabric article;
dosing a rinse water to the laundry washing machine or the laundry wash basin;
applying the rinse water to the washed fabric article; and
spinning the rinse water from the washed fabric article in a spin cycle;
wherein at least one of the wash water and the rinse water is exposed to the solid laundry drainage aid composition before or during application thereof to the soiled or washed fabric article.

10. A method of improving the energy efficiency of machine washing laundry, comprising:
adding a soiled fabric article to a laundry washing machine;
selecting a solid laundry drainage aid composition according to claim 1;
dosing the solid laundry drainage aid composition to the laundry washing machine;
dosing a laundry detergent formulation to the laundry washing machine;
dosing a wash water to the laundry washing machine;
applying the wash water and laundry detergent formulation to the soiled fabric article to provide a washed fabric article;
dosing a rinse water to the laundry washing machine or the laundry wash basin;
applying the rinse water to the washed fabric article; and
spinning the rinse water from the washed fabric article in a spin cycle;
wherein at least one of the wash water and the rinse water is exposed to the solid laundry drainage aid composition before or during application thereof to the soiled or washed fabric article; and wherein the organopolysiloxane in the selected solid laundry drainage aid composition is chosen based on the ability to reduce residual water entrained with the washed fabric article at completion of the spin cycle.
